(19) United States
(12) Patent Application Publication
(10) Pub. No.: US 2024/0112042 A1
(43) Pub. Date: Apr. 4, 2024

(54) METHODS AND COMPUTER DEVICES FOR EVENT DETECTION USING HYBRID INTELLIGENCE

(71) Applicant: Deep Labs, Inc., San Mateo, CA (US)

(72) Inventors: Theodore HARRIS, San Francisco, CA (US); Scott EDINGTON, Arlington, VA (US); Talia BECK, Philadelphia, PA (US); Simon Robert Olov NILSSON, Seattle, WA (US)

(73) Assignee: Deep Labs, Inc., San Mateo, CA (US)

(21) Appl. No.: 18/151,463

(22) Filed: Jan. 8, 2023

Related U.S. Application Data
(60) Provisional application No. 63/411,890, filed on Sep. 30, 2022.

(51) Int. Cl. G06N 5/02

(52) U.S. Cl. CPC G06N 5/02

(57) ABSTRACT

A method for event detection includes: obtaining a subpopulation data from a graph structure for performing a graph analysis, wherein the subpopulation data is associated with personality and demographic characteristics of users; obtaining a user profile associated with a target user; inferring psychological traits of the user by performing the graph analysis based on the user profile and the subpopulation data; performing an outcome linkage analysis based on labeled event outcome profiles and the inferred psychological traits to generate personalized knowledge graph data associated with the target user; and profiling, monitoring, or performing an anomaly detection for event data streams based on the personalized knowledge graph data.

### CROSS REFERENCE TO RELATED APPLICATIONS

This application claims the benefit of priority to U.S. Provisional Application No. 63/411,890 filed on Sep. 30, 2022, which is incorporated herein by reference in its entirety.

### TECHNICAL FIELD

The present disclosure generally relates to machine learning applications. More specifically, and without limitation, the present disclosure relates to systems and methods for profiling, monitoring, and anomaly detection for event data streams in machine learning applications.

### BACKGROUND

Machine learning (ML) and artificial intelligence (AI) systems can be used in various applications to provide streamlined user experiences on digital and cloud-based platforms. AI/ML systems may enable the use of large amounts of data stored in databases, data gathered in knowledge bases, peer information, or data that is otherwise available, such as environmental information. AI/ML systems can quickly analyze massive amounts of data and can provide a user with useful feedback that may guide the user to reach desirable outcomes.

While AI/ML systems are growing exponentially, current AI/ML solutions lack basic human knowledge and common sense, and only have limited ability to understand how events influence outcomes and to provide adaptive interaction with different end-users. In order to solve a wider variety of problems, there is a need to provide an adaptive way to encapsulate human understanding to facilitate ML/AI systems and improve the user experience.

### SUMMARY

In accordance with some embodiments, a method for event detection is provided. The method for event detection includes: obtaining a subpopulation data from a graph structure for performing a graph analysis, wherein the subpopulation data is associated with personality and demographic characteristics of users; obtaining a user profile associated with a target user; inferring psychological traits of the user by performing the graph analysis based on the user profile and the subpopulation data; performing an outcome linkage analysis based on labeled event outcome profiles and the inferred psychological traits to generate personalized knowledge graph data associated with the target user; and profiling, monitoring, or performing an anomaly detection for event data streams based on the personalized knowledge graph data.

In accordance with some embodiments, a computing device is provided. The computing device includes: a memory configured to store computer-executable instructions; and one or more processors coupled to the memory and configured to execute the computer-executable instructions to perform: obtaining a subpopulation data from a graph structure for performing a graph analysis, wherein the subpopulation data is associated with personality and demographic characteristics of users; obtaining a user profile associated with a target user; inferring psychological traits of the user by performing the graph analysis based on the user profile and the subpopulation data; performing an outcome linkage analysis based on labeled event outcome profiles and the inferred psychological traits to generate personalized knowledge graph data associated with the target user; and profiling, monitoring, or performing an anomaly detection for event data streams based on the personalized knowledge graph data.

In accordance with some embodiments, a non-transitory computer-readable storage medium is provided. The non-transitory computer-readable storage medium stores a set of instructions that are executable by one or more processors of a device to cause the device to perform the above method for event detection.

It is to be understood that both the foregoing general description and the following detailed description are exemplary and explanatory only and are not restrictive of the disclosed embodiments, as may be claimed.

### BRIEF DESCRIPTION OF DRAWINGS

FIG. 1 is a diagram of an exemplary server for performing a method for event detection, consistent with some embodiments of the present disclosure.

FIG. 2 is a diagram of an exemplary user device, consistent with some embodiments of the present disclosure.

FIG. 3 is a flowchart diagram of an exemplary computer-implemented method 300 for event detection, consistent with some embodiments of the present disclosure.

FIG. 4A and FIG. 4B are block diagrams illustrating a use case of user psychographic tuning based on the method of FIG. 3, consistent with some embodiments of the present disclosure.

FIG. 5 is a block diagram illustrating more detailed operations performed by the machine learning device in the method of FIG. 3, consistent with some embodiments of the present disclosure.

FIG. 6 is a diagram illustrating an exemplary relationship between personality traits and behaviors according to a study, consistent with some embodiments of the present disclosure.

FIG. 7A and FIG. 7B are diagrams illustrating exemplary charts according to a study, consistent with some embodiments of the present disclosure.

FIG. 8 is an exemplary diagram showing an exemplary ego-network analysis, consistent with some embodiments of the present disclosure.

FIG. 9A and FIG. 9B are exemplary diagrams and showing shifts in words used in conjunction with a keyword according to a study, consistent with some embodiments of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to subject matter described herein.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C. Expressions such as “at least one of” do not necessarily modify an entirety of a following list and do not necessarily modify each member of the list, such that “at least one of A, B, and C” should be understood as including only one of A, only one of B, only one of C, or any combination of A, B, and C. The phrase “one of A and B” or “any one of A and B” shall be interpreted in the broadest sense to include one of A, or one of B.

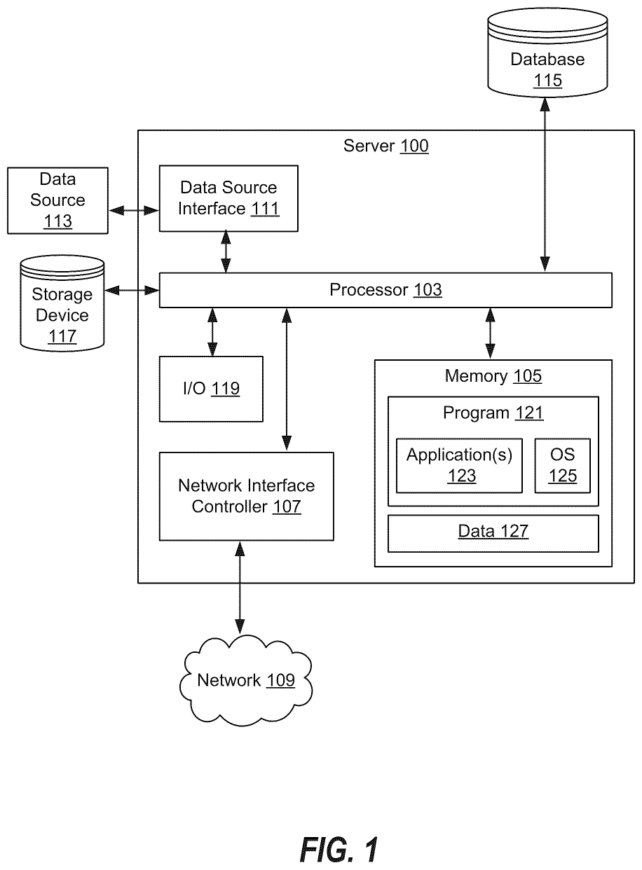

FIG. 1 illustrates a server 100 for implementing a hybrid intelligence system for performing a method for event detection, consistent with embodiments of the present disclosure. The hybrid intelligence system may be configured for profiling, monitoring, and anomaly detection for event data streams, and providing an adaptive way to encapsulate human knowledge and understanding to facilitate ML and AI systems to cover a broader set of use cases.

As shown in FIG. 1, the server 100 may include a processor 103, a memory 105, and a network interface controller 107. The processor 103, which may be a single-core processor or a multi-core processor, includes at least one processor configured to execute one or more programs 121, applications, processes, methods, or other software to perform disclosed embodiments of the present disclosure. In some embodiments, the processor 103 may include one or more circuits, microchips, microcontrollers, microprocessors, central processing unit, graphics processing unit, digital signal processor, or other suitable circuits for executing instructions stored in the memory 105, but the present disclosure is not limited thereto. It is understood that other types of processor arrangements could be implemented.

As shown in FIG. 1, the processor 103 is configured to communicate with the memory 105. The memory 105 may include the one or more programs 121 and data 127. In some embodiments, the memory 105 may include any area where the processor 103 or a computer stores the data 127. A non-limiting example of the memory 105 may include semiconductor memory, which may either be volatile or non-volatile. For example, the non-volatile memory may include flash memory, ROM, PROM, EPROM, and EEPROM memory. The volatile memory may include dynamic random-access memory (DRAM) and static random-access memory (SRAM), but the present disclosure is not limited thereto.

The program 121 stored in the memory 105 may refer to a sequence of instructions in any programming language that the processor 103 may execute or interpret. Non-limiting examples of program 121 may include an operating system (OS) 125, web browsers, office suites, or video games. The program 121 may include at least one of server application(s) 123 and the OS 125. In some embodiments, the server application 123 may refer to software that provides functionality for other program(s) 121 or devices. Non-limiting examples of provided functionality may include facilities for creating web applications and a server environment to run them. Non-limiting examples of server application 123 may include a web server, a server for static web pages and media, a server for implementing business logic, a server for mobile applications, a server for desktop applications, a server for integration with a different database, and any other similar server type. For example, the server application 123 may include a web server connector, a computer programming language, runtime libraries, database connectors, or administration code. The operating system 125 may refer to software that manages hardware, software resources, and provides services for programs 121. The operating system 125 may load the program 121 into the memory 105 and start a process. Accordingly, the processor 103 may perform this process by fetching, decoding, and executing each machine instruction.

As shown in FIG. 1, the processor 103 may communicate with the network interface controller 107. The network interface controller 107 may refer to hardware that connects a computer or the processor 103 to a network 109. In some embodiments, the network interface controller may be a network adapter, a local area network (LAN) card, a physical network interface card, an ethernet controller, an ethernet adapter, a network controller, or a connection card. The network interface controller 107 may be connected to the network 109 wirelessly, by wire, by USB, or by fiber optics. The processor 103 may communicate with an external or internal database 115, which may function as a repository for a collection of data 127. The database 115 may include relational databases, NoSQL databases, cloud databases, columnar databases, wide column databases, object-oriented databases, key-value databases, hierarchical databases, document databases, graph databases, and other similar databases. The processor 103 may communicate with a storage device 117. The storage device 117 may refer to any type of computing hardware that is used for storing, porting, or extracting data files and objects. For example, the storage device 117 may include random access memory (RAM), read-only memory (ROM), floppy disks, and hard disks.

In addition, the processor 103 may communicate with a data source interface 111 configured to communicate with a data source 113. In some embodiments, the data source interface 111 may refer to a shared boundary across which two or more separate components of a computer system exchange information. For example, the data source interface 111 may include the processor 103 exchanging information with data source 113. The data source 113 may refer to a location where the data 127 originates from. The processor 103 may communicate with an input or output (I/O) interface 119 for transferring the data 127 between the processor 103 and an external peripheral device, such as sending the data 127 from the processor 103 to the peripheral device, or sending data from the peripheral device to the processor 103.

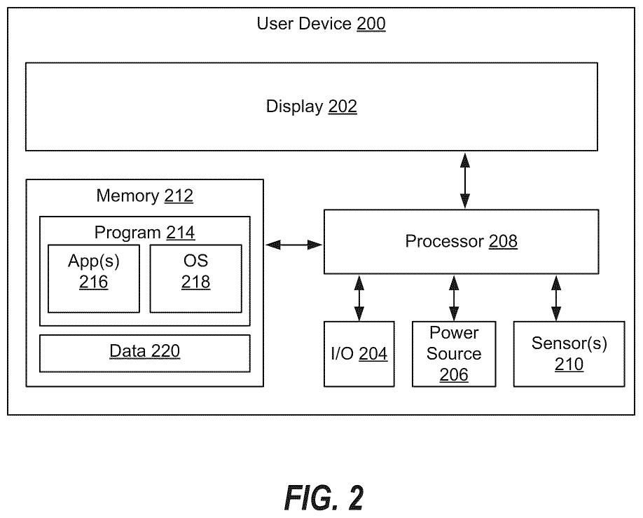

FIG. 2 illustrates a user device 200, consistent with embodiments of the present disclosure. The user device 200 shown in FIG. 2 may refer to any device, instrument, machine, equipment, or software that is capable of intercepting, transmitting, acquiring, decrypting, or receiving any sign, signal, writing, image, sound, or data in whole or in part. For example, the user device 200 may be a smartphone, a tablet, a Wi-Fi device, a network card, a modem, an infrared device, a Bluetooth device, a laptop, a cell phone, a computer, an intercom, etc. In the embodiments of FIG. 2, the user device 200 may include a display 202, an input/output unit 204, a power source 206, one or more processors 208, one or more sensors 210, and a memory 212 storing program(s) 214 (e.g., device application(s) 216 and OS 218) and data 220. The components and units in the user device 200 may be coupled to each other to perform their respective functions accordingly.

As shown in FIG. 2, the display 202 may be an output surface and projecting mechanism that may show text, videos, or graphics. For example, the display 202 may include a cathode ray tube (CRT), liquid crystal display (LCD), light-emitting diode, gas plasma, or other image projection technology.

The power source 206 may refer to hardware that supplies power to the user device 200. In some embodiments, the power source 206 includes a battery. The battery may be a lithium-ion battery. Additionally, or alternatively, the power source 206 may be external to the user device 200 to supply power to the user device 200. The one or more sensors 210 may include one or more image sensors, one or more motion sensors, one or more positioning sensors, one or more temperature sensors, one or more contact sensors, one or more proximity sensors, one or more eye tracking sensors, one or more electrical impedance sensors, or any other technology capable of sensing or measuring. For example, the image sensor may capture images or videos of a user or an environment. The motion sensor may be an accelerometer, a gyroscope, and a magnetometer. The positioning sensor may be a GPS, an outdoor positioning sensor, or an indoor positioning sensor. For example, the temperature sensor may measure the temperature of at least part of the environment or user. For example, the electrical impedance sensor may measure the electrical impedance of the user. The eye-tracking sensor may include a gaze detector, optical trackers, electric potential trackers, video-based eye-trackers, infrared/near infrared sensors, passive light sensors, or other similar sensors. The program 214 stored in the memory 212 may include one or more device applications 216, which may be software installed or used on the user device 200, and an OS 218.

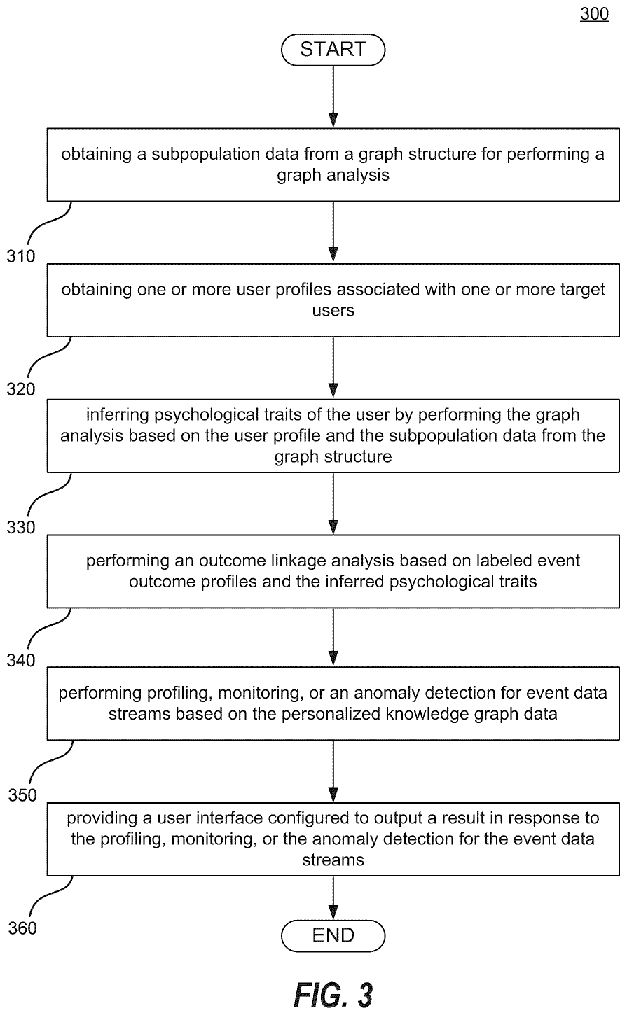

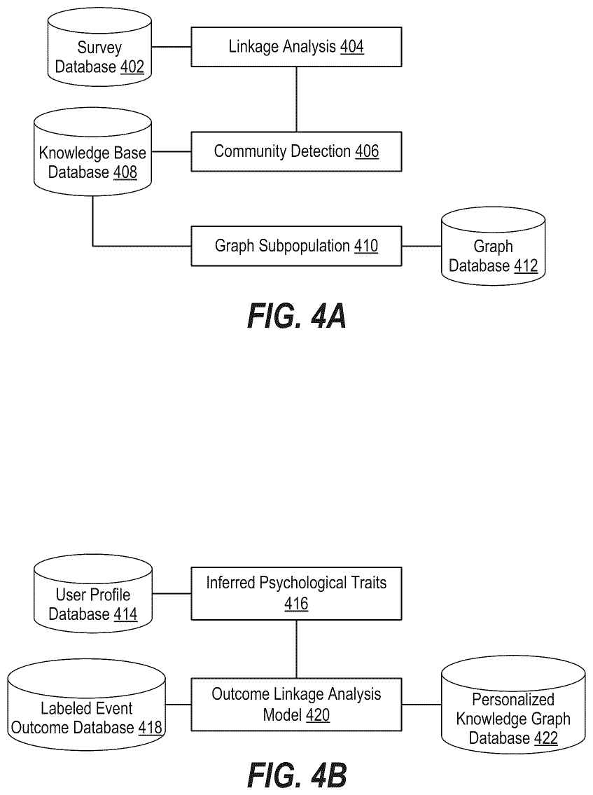

FIG. 3 is a flowchart diagram of an exemplary computer-implemented method 300 for event detection, consistent with some embodiments of the present disclosure. For example, the method 300 can be performed or implemented by software stored in a machine learning device or a computer system, such as the server 100 in FIG. 1 and/or the user device 200 in FIG. 2. For example, the memory 105 in the server 100 may be configured to store instructions, and the one or more processors 103 in the server 100 may be configured to execute the instructions to cause the server 100 to perform the method 300. FIG. 4A and FIG. 4B are block diagrams illustrating a use case of user psychographic tuning based on the method 300 of FIG. 3, consistent with some embodiments of the present disclosure.

As shown in FIG. 3, in some embodiments, method 300 includes steps 310-360, which will be discussed in the following paragraphs.

In step 310, the machine learning device obtains a subpopulation data from a graph structure for performing a graph analysis. In some embodiments, the subpopulation data is associated with personality and demographic characteristics of users. As shown in FIG. 4A, in some embodiments, the machine learning device may build the graph structure by obtaining data from surveys stored in a survey database 402. Then, a linkage analysis 404 can be performed to the obtained data. After the linkage analysis 404, the machine learning device may perform a community detection 406 to obtain community structures to be stored in a Knowledge Base database 408. Then, the community structures in the Knowledge Base database 408 can be merged to obtain the graph structure containing graph subpopulation 410 to be stored in the graph database 412.

Specifically, the survey data can be normalized based on prior survey results, attentiveness scores and prior data from panel participants. The survey data is then expressed as a graph where the survey questions (e.g., a new source preference ranking) are linked to five personalities (e.g., openness, conscientiousness, extroversion, agreeableness, and neuroticism) with binned values (e.g., low, medium, or high). Graph community detection is used to infer any edges (e.g., linking a news source to a personality that was not linked in the survey). Accordingly, the machine learning device may generate new sub-graphs using the inferred edge and original edges for each personality binning. For example, a set of news sources can be linked to a low openness (i.e., conservative) personality.

In step 320, the machine learning device obtains one or more user profiles associated with one or more target users.

In step 330, the machine learning device infers psychological traits of the user by performing the graph analysis based on the user profile and the subpopulation data from the graph structure. Psychological traits may include the big five personality traits, which is a suggested taxonomy for personality traits identifying five factors of openness to experience (inventive/curious vs. consistent/cautious), conscientiousness (efficient/organized vs. extravagant/careless), extraversion (outgoing/energetic vs. solitary/reserved), agreeableness (friendly/compassionate vs. critical/rational), and neuroticism (sensitive/nervous vs. resilient/confident). In some embodiments, psychological traits may also include other factors, such as impulsiveness.

In step 340, the machine learning device performs an outcome linkage analysis based on labeled event outcome profiles and the inferred psychological traits to generate personalized knowledge graph data associated with the target user.

As shown in FIG. 4B, in some embodiments, user profile(s) can be stored in a user profile database 414. The inferred psychological traits 416 associated with the target user obtained in the step 330 and the labeled event outcome profiles stored in a labeled event outcome database 418 are provided to an outcome linkage analysis model 420 and processed to generate personalized knowledge graph data, which can be stored in a personalized knowledge graph data database 422.

In the embodiments of FIG. 4A and FIG. 4B, user's activity profiles, such as the merchants the users have shopped at, are used to generate a graph. The similarity measures (e.g., Jaccard similarity coefficient) of the user's graph and each personality binned graphs can be obtained. For each personality trait, the binned graph of the personality trait with the highest values is used to identify the user's personality. In some embodiments, the user's personality traits plus the user data, such as location information, can then be used as inputs into a prior-built supervised model to predict outcomes. The predicted outcome data can then be stored in the knowledge base for future reference.

Then, in step 350, the machine learning device performs profiling, monitoring, or an anomaly detection for event data streams based on the personalized knowledge graph data. By applying the operations 310-350 above, latent graph embeddings can be uncovered when an analyst assigns a decision or adds information to a record or a set of records. Using these latent embeddings powered by psychographic and situational data from the platform and the client data, the machine learning device may create a signature to match similar user profiles within the database. In addition, the machine learning device can analyze the target decision-makers to understand psychographic factors that may be influencing their decision process and create a rule on-the-fly based on human decisions. Via a hybrid-intelligence interface, the signature can be provided for further analysis to gain insight into the decision-making process, and can be used to create surveys automatically to further leverage human insights.

In step 360, the machine learning device provides a user interface configured to output a result in response to the profiling, monitoring, or the anomaly detection for the event data streams. In some embodiments, the analyst may directly interface with the latent graph data space in order to encapsulate the human knowledge and directly embed the knowledge into a hyper dimension information space creating a latent connection not seen by the analysis. When an analyst directly injects information, the information space can be rebuilt accordingly to surface new insights, tune the additional data in the analysis, and confirm its validity.

For example, the machine learning device may provide an investigation dashboard configured to enable an analyst to perform various operations. In some embodiments, anomalies are monitored via the user interface at an individual level and/or a macro level. In some other embodiments, one or more event flagged by prior rules can be viewed via the user interface. In some other embodiments, an analyst may manually create and inject new information, manually create linkage between events, data, or outcomes, manually label outcomes or flag events or a collection of events accordingly via the user interface, such that the machine learning device can receive manually created data or linkage, and receive data for manually labeled outcomes or flagged events via the user interface.

The method 300 can be applied to facilitate ML/AI-based systems for different use cases. Example use cases may include: flagging a tax return for an audit, appending human knowledge/intelligence to a news article, select top-tier cardholders for enhanced terms, selecting merchants for partnerships, flagging a transaction for a suspicious return, identifying customers at risk of churn (e.g., call center feedback from a complaint), selecting profiles based on the outcome of a marketing campaign, flagging false positives in data, etc., but the present disclosure is not limited thereto.

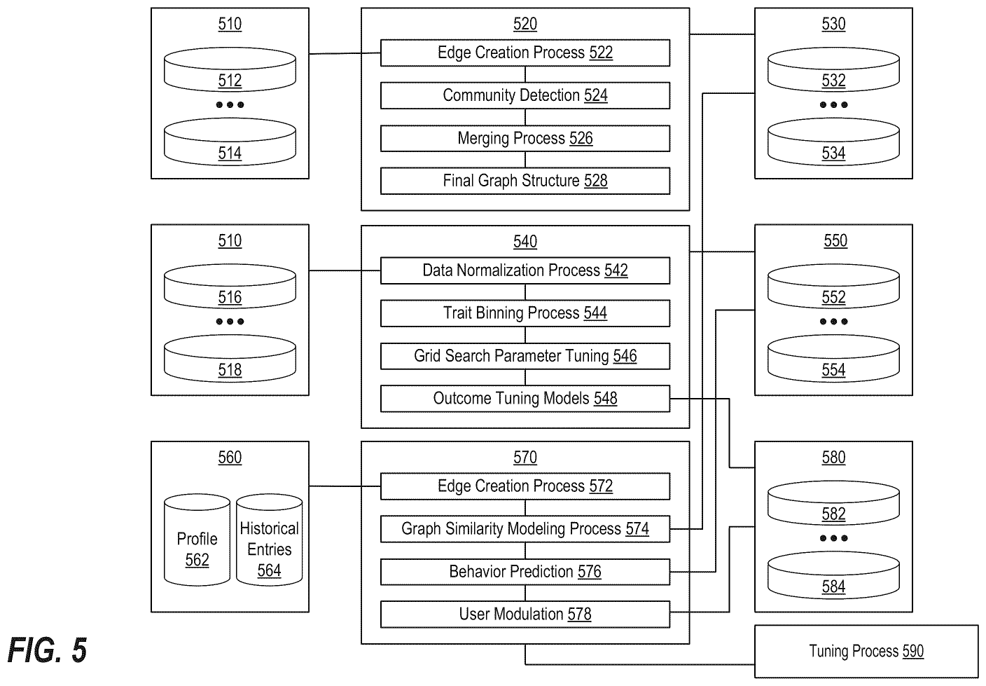

FIG. 5 is a block diagram illustrating more detailed operations performed by the machine learning device in the method 300 of FIG. 3, consistent with some embodiments of the present disclosure. In the embodiments of FIG. 5, the machine learning device may determine personality profiles and tune user entries according to psychographic data. Specifically, the machine learning device may obtain data from a plurality of psychographic surveys 512, 514 stored in a survey database 510.

The graph building unit 520 and the model building unit 540 in the embodiments of FIG. 5 show more details regarding the operations in FIG. 4A above. By a graph building unit 520, the machine learning device may perform an edge creation process 522 based on the obtained data, perform a community detection 524 to obtain community structures, and perform a merging process 526 to merge the community structures to obtain the final graph structure 528 including information of the psychological traits. As shown in FIG. 5, the graph building unit 520 may store the graph in a graph database 530, which includes a plurality of psychological trait data 532, 534.

In some embodiments, the final graph structure can be determined by looking at historical performance of prior models and determining whether any vertices metrics (e.g., centrality, PageRank, etc.) is correlated with a poor performance. When the correlation with the poor performance exceeds a predetermined threshold, those vertices are excluded. For example, if a vertex is a general news aggregator that all personality types read, it would be identified as contributing to high noise and excluded in this step.

In addition, the machine learning device may build and tune one or more behavior models according to behavior surveys. For example, the machine learning device may obtain data from a plurality of behavior surveys 516, 518 stored in the survey database 510. By a model building unit 540, the machine learning device may perform a data normalization process 542 to the obtained data. Then, in a trait binning process 544, the machine learning device may bin the normalized data. After the trait binning process 544, the machine learning device can then perform a grid search parameter tuning 546 to tune the behavior model with behavior profiles to obtain the outcome tuning model(s) 548. In some embodiments, the machine learning device may use outcome profiles 582, 584 stored in an outcome database 580 to tune the one or more behavior models. The obtained behavior models 552, 554 can be stored in a model database 550.

The model building unit 540 is configured to clean the user data and remove poorly measured values. Values used to generate the graph (e.g., preferred news sources) are binned to low, medium, and high, as was done in the graph building unit 520. For each identified target (which has to bias towards conflicts, etc.), supervised models can be trained in a semi-autonomous fashion using automatic grid search across supervised model parameters (e.g., number of trees). The final model can be selected from a bank of generated supervised models using each parameterization by the modeler.

The machine learning device may obtain user data associated with the target user from a user database 560. For example, the user data may include the user profile 562 and corresponding historical entries 564. Then, by a tuning unit 570, the machine learning device may perform an edge creation process 572 based on the obtained user data, perform a graph similarity modeling process 574 for psychological traits according to the graph structure, and perform a behavior prediction 576 according to one or more behavior models 552, and 554 with behavior profiles. Then, a user modulation 578 is performed, based on the outcome linkage analysis, to obtain outcome profiles 582 and 584. After receiving the behavior and outcome profiles, the machine learning device may accordingly perform a tuning process 590 to tune the user contributes based on the behavior and outcome profiles. The tuning unit 570 in the embodiments of FIG. 5 show more details regarding the operations in FIG. 4B above. In particular, user input can be modulated based on outcome analysis. For example, if the user has a high degree of anxiety and is threaten by military build-up, the threat analysis would be downward adjusted at an early stage of a build-up compared with a analyst with no such personality of behavior traits. These adjustments can be determined by supervised model(s) based on historical data.

In some embodiments, the machine learning device may identify deception and misinformation (e.g., exploitative motifs) in media by focusing on understanding how linguistic patterns influence different people. Particularly, different subpopulations, as defined by personality and demographic characteristics, are influenced and react differently to exploitative motifs. By leveraging the extensive survey data, contextual and financial outcome data, a humanistic Natural Language Processing (NLP) framework is created for monitoring and extracting understanding from unstructured data. For processing unstructured data, the humanistic NLP/Linguistic engine used in various embodiments of the present disclosure may perform a deep learning NLP processing with psychological profiling models to normalize unstructured text content to provide cleaner signals to downstream AI systems.

In some embodiments, news articles may be a primary source of signals for the platform, and the client-specific unstructured data can be weaved into the data fabric on the platform seamlessly. When a user wishes to directly steer the ML/AI model using specific expert knowledge data, the data obtained from the user can be viewed as another high priority news source. The platform may be able to analyze the news articles and the journalists writing the news articles to normalize the signals based on psychographics and prior performance using psychological and economic models.

In some embodiments, the platform may include a data ingestion subunit configured to enable flexible and fast data ingestion, normalization, and featurization. In some embodiments, transformation rules applied in the data ingestion subunit can be expressed in metadata to enable quick reuse. When a new data source is added, the new data source can be analyzed and matched again with prior signals to select the most similar metadata to use. The data ingestion subunit may be configured to receive event data associated with different participants of the cloud services from the event database, and data associated with the configuration or global insights of the cloud services from the cloud database. In some embodiments, the data ingestion subunit may process unstructured data gathered from multiple sources in various formats and operationalize the gathered data. For example, types of input data may include image data, unstructured data, graph data, categorical data, contentious wavelets, but the present disclosure is not limited thereto. For image data, the output of the data ingestion subunit may include neural network (NN) Tagging data and/or metadata extraction data. For unstructured data, the output of the data ingestion subunit may include Natural language processing (NLP) data and/or Bidirectional Encoder Representations from Transformers (BERT) data, For graph data, the output of the data ingestion subunit may include nodes and edges associated with the graph data. For categorical data, the output of the data ingestion subunit may include one-hot encoding data and/or index look-up information. For continuous wavelets, the output of the data ingestion subunit may include wavelets, fuzzy features, and/or binning information. The data ingestion subunit may also receive human-derived or interactive feedback data from one or more participants for tuning the network signals. In some embodiments, an automated quality control (QC) may perform the quality control by generating a series of metrics that are used for both quality control and model selection. Exemplary key metrics may include data such as Kolmogorov-Smirnov test data, Shapiro-Wilk data, basic statistic data (e.g., min value, max value, mean value, STD value, median value, etc.), Chi-square goodness-of-fit data, etc.

By the data ingestion and processing performed by the data ingestion subunit, the platform is able to ingest information from a wide variety of sources, including data sources that have not been prepared or processed specifically for use with neural network systems. Accordingly, the platform may provide more flexibilities and allow the neural network system to process the data more efficiently and accurately regardless of the format of the data sources, which enables the neural network system to process and react to information from various indiscriminate and random sources. The data ingestion process performed by the data ingestion subunit also involves wavelet processing, which is described in more detail in U.S. Publication No. 2021/0073652, U.S. Publication No. 2021/0110387, and U.S. Pat. No. 11,182,675, contents of which are hereby incorporated by reference in their entirety.

Specifically, the humanistic NLP framework can be used to leverage psychology and sociology methodologies and tuned to a specific reader's or population's psychographics and lexicon to assure accurate signal extraction for downstream ML/AI systems. In some embodiments, the humanistic NLP framework can also be used to correct any conscious or unconscious biases for a specific narrator or entity. By linking the extracted topics and subjected matter of the analyzed text to the user's preidentified attributes towards the topics and subject matters (or similar topics or subject matters), based on personality analysis and prior report bias, the humanistic NLP framework can identify potential biases. Then, the platform can perform corresponding actions, such as filtering text to restrict parts corresponding to biases, adjusting any output metrics, such as risk scores, derived from the text, adjusting any meta-linkage derived from the text. For example, if a user is biased towards the nuclear power, the risk assessment would be downwardly adjusted to correct for the writer's (or reader's) biases. The adjustments of the risk scores can be based on the output analysis of prior scores of historical data with similar inputs and biases.

Thus, the machine learning device can perform a signal extraction for a downstream AI model based on the personalized knowledge graph data. Accordingly, the machine learning device may identify types of motifs, keywords, and other linguistic patterns best uncovered deceptive practices after identifying the characteristics of the target user being influenced, and identifying which technique provides a significant impact. For example, in some embodiments, the system may build one or more personality or emotional profile models for the persona category using a wavelet analysis model, a natural language processing (NLP) embedding model, a graph embedding model, a semi-supervised model, or any combination thereof. For example, the profiling model may also be built using a combination of other data processing or data analysis methods, such as using various semi-supervised AI and ML learners. In some embodiments, the data sources used in the models may include psychology studies correlating financial outcome to key physiological measures, financial transactional data, NLP embeddings, user digital footprint, event data, and/or other open datasets or census data, etc. An example of the psychology studies may be the study of the influence of exploitive motifs on purchase behavior given personality traits and a modified coin toss experiment to determine truthfulness under a variety of purchase scenarios. An example of the financial transactional data may include credit card or purchase card transactions. In some embodiments, the NLP embeddings may be built from, but not limited to, tweets, financial complaints, and/or merchant's websites. The event data may include weather data, news data, sporting event data, tweets or other social media posts or contents on various platforms.

In some embodiments, the signal extraction can be performed by extracting signals associated with one or more text complexity metrics. The text complexity metrics may include an average height of syntax trees, an average word count, a sentence length, an information entropy, or any combination thereof. In some embodiments, the signal extraction can be performed by extracting signals associated with an emotional content or a personality content by text classification. In some embodiments, the signal extraction can be performed by performing a demographic inference by text classification using keywords and linguistic patterns correlated with demographic profiles.

In some embodiments, the signal extraction can be performed by performing a motif matching and anomaly detection by identifying motifs via matching against a motif database. In some embodiments, the signal extraction can be performed by performing a behavioral designed motifs detection by identifying manipulative or coercive phrasing using a series of regular expressions. In some embodiments, the signal extraction can be performed by extracting signals associated with one or more linkage analysis metrics. In some embodiments, the signal extraction can be performed by performing a sentiment analysis to, based on one or more pre-trained sentiment analysis model, determine positive, negative, or neutral sentiment contained in a text.

In some embodiments, an extensive survey database can be designed to understand the regional differences that drive the response of the actors to events. Different studies can be created to aid the AI-based platform, in which each study is designed to be fed into an AI engine to refine the persona identification, to better understand factors driving outcomes, or aid in recommending the next best actions.

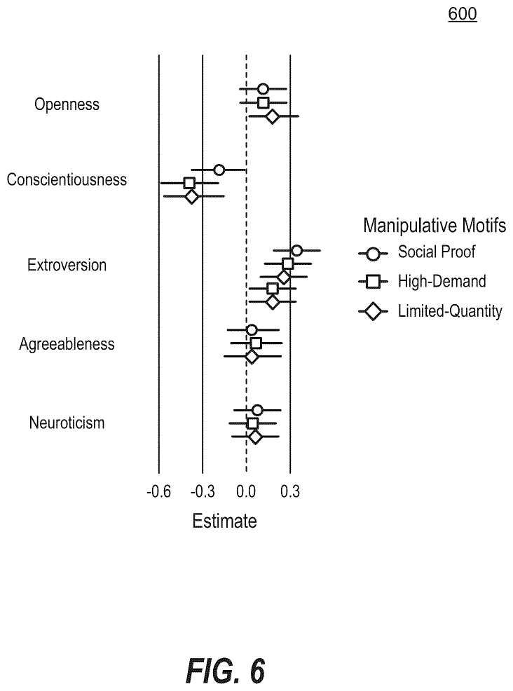

FIG. 6 is a diagram 600 illustrating an exemplary relationship between personality traits and participants' behaviors, consistent with some embodiments of the present disclosure. In the embodiments of FIG. 6, a study simulates an online checkout environment with various dark patterns, and measures how personality traits explained participants' impulsive behavior. The term dark patterns refer to design interfaces or features that subtly manipulate people in making suboptimal decisions and are ubiquitous in e-commerce websites. Examples of dark patterns may include: social proof (e.g., usage or possession of the product by peers or celebrities, positive customer testimonials, etc.), limited-quantity scarcity (e.g., a message of “only 3 left in stock”), limited-time scarcity (e.g., a message of “limited time offer—this offer ends in 24 hours”), and high demand (e.g., a message of “item is in high demand”). FIG. 6 shows how individuals identified with different personality traits (e.g., openness, conscientiousness, extroversion, agreeableness, and neuroticism) react differently to different manipulative motifs (e.g., social proof, high-demand, and limited-quantity scarcity). The x-axis is an estimate value that indicates the level of greater average purchase impulsivity triggered by the corresponding manipulative motif associated with each personality trait. From the research results shown in FIG. 6, it is shown that the personality can be impactful in how people react to information such as advertisements, and the external stimuli may not have the same impact to different personality traits.

For example, more individuals with openness personality trait have greater average purchase impulsivity when exposed to limited-quantity advertisement. On the other hand, fewer individuals with conscientiousness personality trait have greater average purchase impulsivity when exposed to all dark patterns, except for the social proof dark pattern. In addition, it shows no evidence that dark patterns significantly increase or decrease online purchase impulsivity for individuals with neuroticism personality trait.

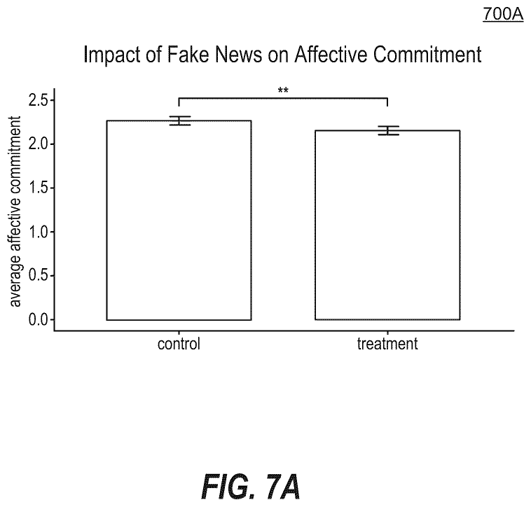

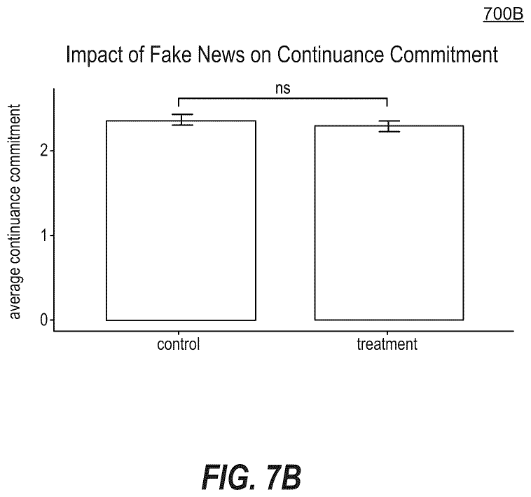

FIG. 7A and FIG. 7B are exemplary charts 700A and 700B showing the impact of fake news on affective commitment or on continuance commitment according to a study, consistent with some embodiments of the present disclosure. The example study of FIG. 7A and FIG. 7B focuses on the impact of news on decision-making, and explores how fake news on products influences a product's choice.

Key findings shown in charts 700A and 700B and the study are that fake news may significantly reduce the brand loyalty, but only for affective commitment in chart 700A. With respect to fake news, brands relying on emotional connection and resonance may face a greater threat to brand loyalty than those brands holding a monopoly over the market. In other words, given the opportunity, current consumers will switch brands when exposed to fake news if there are alternatives in the marketplace, and especially so if the brands have more instrumental than emotional resonance. The two asterisks (i.e., “**”) in chart 700A indicates that the P value is less than or equal to a corresponding threshold (e.g., 0.01), and the impact of fake news on average affective commitment levels in the control group and in the treatment group is considered statistically significant. On the other hand, the “ns” denoted in chart 700B indicates that the P value is higher than a threshold (e.g., 0.05), and the impact of fake news on average continuance commitment levels in the control group and in the treatment group result is considered non-significant. That is, the result does not allow the researcher to conclude that differences in the data obtained for different samples are meaningful and legitimate.

The above findings enable the platform to build a better model for evaluating which topics and articles are under highest threat of disinformation. Other surveys may also be conducted to analyze how the news impacts consumer behavior or choice. For example, personality traits and social-economic factors may both drive participants' responses. Details of dark patterns can be found in other articles (see, e.g., Sin, R., Harris, T., Nilsson, S., & Beck, T, “Dark patterns in online shopping: Do they work and can nudges help mitigate impulse buying?” Behavioural Public Policy, 1-27 (2022) and Mathur, A., Acar, G., Friedman, M. J., Lucherini, E., Mayer, J., Chetty, M., & Narayanan, A, “Dark Patterns at Scale: Findings from a Crawl of 11K Shopping Websites” Proceedings of the ACM on Human-Computer Interaction, 3, 81 (2019), contents of which are hereby incorporated by reference in their entirety.

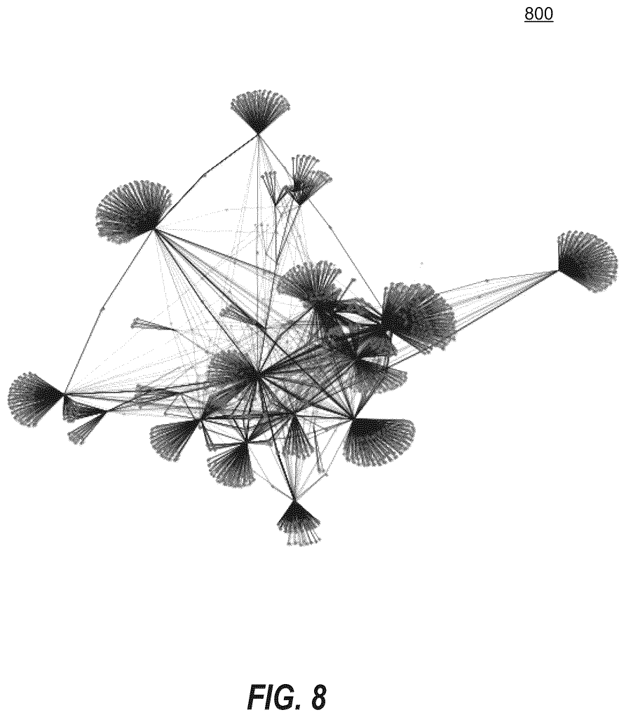

FIG. 8 is an exemplary diagram 800 showing an exemplary ego-network analysis, consistent with some embodiments of the present disclosure. The diagram 800, which can be obtained by the graph modeling, show the ego-network analysis of a user who sends messages regarding a specific topic on a social media network (e.g., on Twitter). Specifically, an analyst can conduct research into the spread of knowledge through social media and generate a visualization or graph of how websites and/or accounts are interconnected, to understand how the actors anticipate the information to spread, which is one key aspect of deceptive information. Using the network data, a linkage analysis of keywords can be crafted to enable a view of potential impact of a target article, and enable an analyst to determine whether an article was crafted for a particular audience in terms of facilitating a viral spread of information.

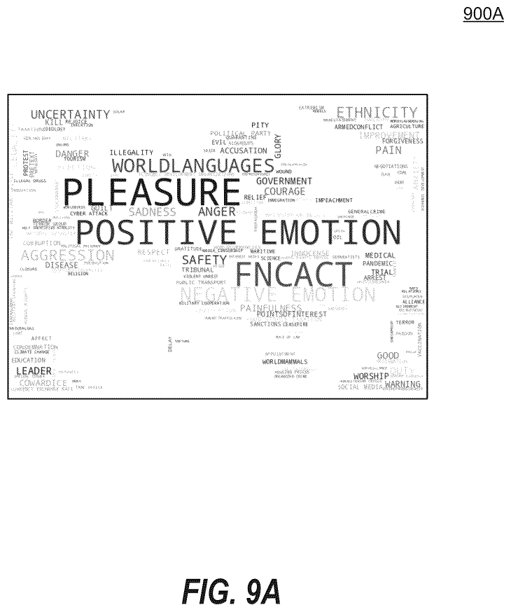

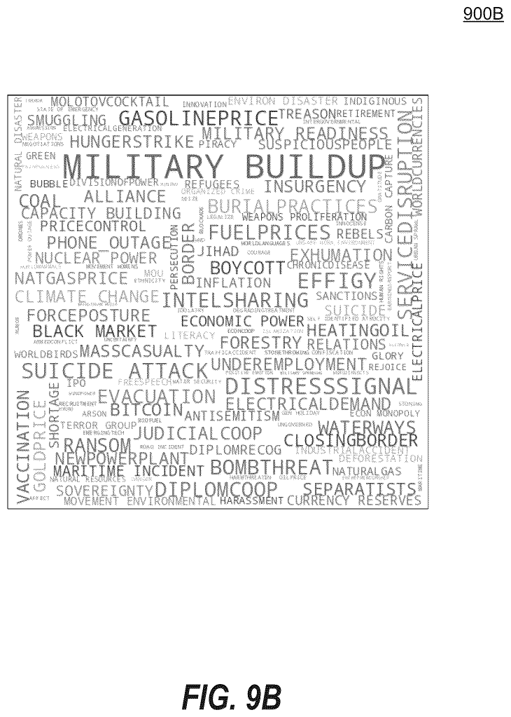

FIG. 9A and FIG. 9B are exemplary diagrams 900A and 900B showing shifts in words used in conjunction with a keyword according to a study, consistent with some embodiments of the present disclosure. For example, diagrams 900A and 900B may show the shifts in words used in conjunction with a region before and after a critical event (e.g., a war). By tracking news, social media, and other unstructured news sources, the platform may detect drifts in linguistic patterns more efficiently to achieve the contextual normalization and the noise reduction. For example, an example recent trend is the rise of “clickbait” in headlines, where the headline appears to be false while the contents are more factual. In one study of RSS feed headlines, up to about 20% of the headlines include characteristics of clickbait, which is important when emerging trends impact the performance of models.

In some embodiments, the platform may perform the monitoring and the drift detection when a target article is identified. For example, a persona engine can be used to monitor the target article as an entity, and look for drift in wording, usual traffic patterns, unexpected usage within social media, unexpected linkage to external sites, unusual linkage in news articles, shifts in used motifs, or any combination thereof.

In view of the above, by performing the method for event detection disclosed in the above embodiments, a hybrid intelligence for profiling, monitoring, and anomaly detection for event data streams can be realized to provide an adaptive way to encapsulate human understanding to facilitate ML/AI systems, and provide human interaction that are adaptive to different end-users for a broader set of use cases.

In some embodiments, a non-transitory computer-readable storage medium including instructions is also provided, and the instructions may be executed by one or more processors of a device, to cause the device to perform the above-described methods for event detection. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Block diagrams in the figures may illustrate the architecture, functionality, and operation of possible implementations of systems, methods, and computer hardware or software products according to various exemplary embodiments of the present disclosure. In this regard, each block in a schematic diagram may represent certain arithmetical or logical operation processing that may be implemented using hardware such as an electronic circuit. Blocks may also represent a module, segment, or portion of code that includes one or more executable instructions for implementing the specified logical functions. It should be understood that in some alternative implementations, functions indicated in a block may occur out of the order noted in the figures. For example, two blocks shown in succession may be executed or implemented substantially concurrently, or two blocks may sometimes be executed in reverse order, depending upon the functionality involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

It will be appreciated that the embodiments of the present disclosure are not limited to the exact construction that has been described above and illustrated in the accompanying drawings, and that various modifications and changes may be made without departing from the scope thereof. The present disclosure has been described in connection with various embodiments, other embodiments of the invention will be apparent to those skilled in the art from consideration of the specification and practice of the invention disclosed herein.

The embodiments may further be described using the following clauses:
1. A method for event detection, comprising:
   obtaining a subpopulation data from a graph structure for performing a graph analysis, wherein the subpopulation data is associated with personality and demographic characteristics of users;
   obtaining a user profile associated with a target user;
   inferring psychological traits of the user by performing the graph analysis based on the user profile and the subpopulation data;
   performing an outcome linkage analysis based on labeled event outcome profiles and the inferred psychological traits to generate personalized knowledge graph data associated with the target user; and
   profiling, monitoring, or performing an anomaly detection for event data streams based on the personalized knowledge graph data.
2. The method of clause 1, further comprising building the graph structure by:
   obtaining data from a plurality of psychographic surveys stored in a survey database;
   performing an edge creation process based on the obtained data;
   performing a community detection to obtain community structures; and
   merging the community structures to obtain the graph structure comprising information of the psychological traits.
3. The method of clause 1, further comprising building and tuning one or more behavior models by:
   obtaining data from a plurality of behavior surveys stored in the survey database;
   performing a data normalization to the obtained data;
   binning the normalized data;
   performing grid search parameter tuning to tune the one or more behavior models with behavior profiles; and
   using outcome profiles to tune the one or more behavior models.
4. The method of clause 1, further comprising:
   obtaining user data associated with the target user, the user data comprising the user profile and historical entries;
   performing an edge creation process based on the obtained user data;
   performing a graph similarity modeling process for psychological traits according to the graph structure.
   performing a behavior prediction according to one or more behavior models with behavior profiles;
   performing a user modulation, based on the outcome linkage analysis, to obtain outcome profiles; and
   tuning user contributes based on the behavior and outcome profiles.
5. The method of clause 1, further comprising:
   providing a user interface configured to output a result in response to the profiling, monitoring, or the anomaly detection for the event data streams.
6. The method of clause 5, wherein anomalies are monitored via the user interface at an individual level and a macro level.
7. The method of clause 5, wherein one or more event flagged by prior rules are viewed via the user interface.
8. The method of clause 5, further comprising:
   receiving, via a user interface, manually created data or linkage; and
   receiving, via the user interface, data for manually labeled outcomes or flagged events.
9. A computing device, comprising:
   a memory configured to store computer-executable instructions; and
   one or more processors coupled to the memory and configured to execute the computer-executable instructions to perform:
   obtaining a subpopulation data from a graph structure for performing a graph analysis, wherein the subpopulation data is associated with personality and demographic characteristics of users;
   obtaining a user profile associated with a target user;
   inferring psychological traits of the user by performing the graph analysis based on the user profile and the subpopulation data;
   performing an outcome linkage analysis based on labeled event outcome profiles and the inferred psychological traits to generate personalized knowledge graph data associated with the target user; and profiling, monitoring, or performing an anomaly detection for event data streams based on the personalized knowledge graph data.
10. The computing device of clause 9, wherein the one or more processors are configured to execute the computer-executable instructions to further perform building the graph structure by:
   obtaining data from a plurality of psychographic surveys stored in a survey database;
   performing an edge creation process based on the obtained data;
   performing a community detection to obtain community structures; and
   merging the community structures to obtain the graph structure comprising information of the psychological traits.
11. The computing device of clause 9, wherein the one or more processors are configured to execute the computer-executable instructions to further perform building and tuning one or more behavior models by:
   obtaining data from a plurality of behavior surveys stored in the survey database;
   performing a data normalization to the obtained data;
   binning the normalized data;
   performing grid search parameter tuning to tune the one or more behavior models with behavior profiles; and
   using outcome profiles to tune the one or more behavior models.
12. The computing device of clause 9, wherein the one or more processors are configured to execute the computer-executable instructions to further perform:
   obtaining user data associated with the target user, the user data comprising the user profile and historical entries;
   performing an edge creation process based on the obtained user data;
   performing a graph similarity modeling process for psychological traits according to the graph structure.
   performing a behavior prediction according to one or more behavior models with behavior profiles;
   performing a user modulation, based on the outcome linkage analysis, to obtain outcome profiles; and
   tuning user contributes based on the behavior and outcome profiles.
13. The computing device of clause 9, wherein the one or more processors are configured to execute the computer-executable instructions to further perform:
   providing a user interface configured to output a result in response to the profiling, monitoring, or the anomaly detection for the event data streams.
14. The computing device of clause 13, wherein anomalies are monitored via the user interface at an individual level and a macro level.
15. The computing device of clause 13, wherein one or more event flagged by prior rules are viewed via the user interface.
16. The computing device of clause 13, wherein the one or more processors are configured to execute the computer-executable instructions to further perform:
   receiving, via a user interface, manually created data or linkage; and
   receiving, via the user interface, data for manually labeled outcomes or flagged events.
17. A non-transitory computer-readable storage medium storing a set of instructions that are executable by one or more processors of a device to cause the device to perform a method for event detection, the method comprising:
   obtaining a subpopulation data from a graph structure for performing a graph analysis, wherein the subpopulation data is associated with personality and demographic characteristics of users;
   obtaining a user profile associated with a target user;
   inferring psychological traits of the user by performing the graph analysis based on the user profile and the subpopulation data;
   performing an outcome linkage analysis based on labeled event outcome profiles and the inferred psychological traits to generate personalized knowledge graph data associated with the target user; and
   profiling, monitoring, or performing an anomaly detection for event data streams based on the personalized knowledge graph data.
18. The non-transitory computer-readable storage medium of clause 17, wherein the method further comprising: building the graph structure by:
   obtaining data from a plurality of psychographic surveys stored in a survey database;
   performing an edge creation process based on the obtained data;
   performing a community detection to obtain community structures; and
   merging the community structures to obtain the graph structure comprising information of the psychological traits.
19. The non-transitory computer-readable storage medium of clause 17, wherein the method further comprising: building and tuning one or more behavior models by:
   obtaining data from a plurality of behavior surveys stored in the survey database;
   performing a data normalization to the obtained data;
   binning the normalized data;
   performing grid search parameter tuning to tune the one or more behavior models with behavior profiles; and
   using outcome profiles to tune the one or more behavior models.
20. The non-transitory computer-readable storage medium of clause 17, wherein the method further comprising:
   obtaining user data associated with the target user, the user data comprising the user profile and historical entries;
   performing an edge creation process based on the obtained user data;
   performing a graph similarity modeling process for psychological traits according to the graph structure.
   performing a behavior prediction according to one or more behavior models with behavior profiles;
   performing a user modulation, based on the outcome linkage analysis, to obtain outcome profiles; and
   tuning user contributes based on the behavior and outcome profiles.

What is claimed is:

1. A method for event detection, comprising:
obtaining a subpopulation data from a graph structure for performing a graph analysis, wherein the subpopulation data is associated with personality and demographic characteristics of users;
obtaining a user profile associated with a target user;
inferring psychological traits of the user by performing the graph analysis based on the user profile and the subpopulation data;
performing an outcome linkage analysis based on labeled event outcome profiles and the inferred psychological traits to generate personalized knowledge graph data associated with the target user; and
profiling, monitoring, or performing an anomaly detection for event data streams based on the personalized knowledge graph data.

2. The method of claim 1, further comprising building the graph structure by:
obtaining data from a plurality of psychographic surveys stored in a survey database;
performing an edge creation process based on the obtained data;
performing a community detection to obtain community structures; and
merging the community structures to obtain the graph structure comprising information of the psychological traits.

3. The method of claim 1, further comprising building and tuning one or more behavior models by:
obtaining data from a plurality of behavior surveys stored in the survey database;
performing a data normalization to the obtained data;
binning the normalized data;
performing grid search parameter tuning to tune the one or more behavior models with behavior profiles; and
using outcome profiles to tune the one or more behavior models.

4. The method of claim 1, further comprising:
obtaining user data associated with the target user, the user data comprising the user profile and historical entries;
performing an edge creation process based on the obtained user data;
performing a graph similarity modeling process for psychological traits according to the graph structure;
performing a behavior prediction according to one or more behavior models with behavior profiles;
performing a user modulation, based on the outcome linkage analysis, to obtain outcome profiles; and
tuning user contributes based on the behavior and outcome profiles.

5. The method of claim 1, further comprising:
providing a user interface configured to output a result in response to the profiling, monitoring, or the anomaly detection for the event data streams.

6. The method of claim 5, wherein anomalies are monitored via the user interface at an individual level and a macro level.

7. The method of claim 5, wherein one or more event flagged by prior rules are viewed via the user interface.

8. The method of claim 5, further comprising:
receiving, via a user interface, manually created data or linkage; and
receiving, via the user interface, data for manually labeled outcomes or flagged events.

9. A computing device, comprising:
a memory configured to store computer-executable instructions; and
one or more processors coupled to the memory and configured to execute the computer-executable instructions to perform:
obtaining a subpopulation data from a graph structure for performing a graph analysis, wherein the subpopulation data is associated with personality and demographic characteristics of users;
obtaining a user profile associated with a target user;
inferring psychological traits of the user by performing the graph analysis based on the user profile and the subpopulation data;
performing an outcome linkage analysis based on labeled event outcome profiles and the inferred psychological traits to generate personalized knowledge graph data associated with the target user; and
profiling, monitoring, or performing an anomaly detection for event data streams based on the personalized knowledge graph data.

10. The computing device of claim 9, wherein the one or more processors are configured to execute the computer-executable instructions to further perform building the graph structure by:
obtaining data from a plurality of psychographic surveys stored in a survey database;
performing an edge creation process based on the obtained data;
performing a community detection to obtain community structures; and
merging the community structures to obtain the graph structure comprising information of the psychological traits.

11. The computing device of claim 9, wherein the one or more processors are configured to execute the computer-executable instructions to further perform building and tuning one or more behavior models by:
obtaining data from a plurality of behavior surveys stored in the survey database;
performing a data normalization to the obtained data;
binning the normalized data;
performing grid search parameter tuning to tune the one or more behavior models with behavior profiles; and
using outcome profiles to tune the one or more behavior models.

12. The computing device of claim 9, wherein the one or more processors are configured to execute the computer-executable instructions to further perform:
obtaining user data associated with the target user, the user data comprising the user profile and historical entries;
performing an edge creation process based on the obtained user data;
performing a graph similarity modeling process for psychological traits according to the graph structure;
performing a behavior prediction according to one or more behavior models with behavior profiles;
performing a user modulation, based on the outcome linkage analysis, to obtain outcome profiles; and
tuning user contributes based on the behavior and outcome profiles.

13. The computing device of claim 9, wherein the one or more processors are configured to execute the computer-executable instructions to further perform:
providing a user interface configured to output a result in response to the profiling, monitoring, or the anomaly detection for the event data streams.

14. The computing device of claim 13, wherein anomalies are monitored via the user interface at an individual level and a macro level.

15. The computing device of claim 13, wherein one or more event flagged by prior rules are viewed via the user interface.

16. The computing device of claim 13, wherein the one or more processors are configured to execute the computer-executable instructions to further perform:
receiving, via a user interface, manually created data or linkage; and
receiving, via the user interface, data for manually labeled outcomes or flagged events.

17. A non-transitory computer-readable storage medium storing a set of instructions that are executable by one or more processors of a device to cause the device to perform a method for event detection, the method comprising:
obtaining a subpopulation data from a graph structure for performing a graph analysis, wherein the subpopulation data is associated with personality and demographic characteristics of users;
obtaining a user profile associated with a target user;
inferring psychological traits of the user by performing the graph analysis based on the user profile and the subpopulation data;
performing an outcome linkage analysis based on labeled event outcome profiles and the inferred psychological traits to generate personalized knowledge graph data associated with the target user; and
profiling, monitoring, or performing an anomaly detection for event data streams based on the personalized knowledge graph data.

18. The non-transitory computer-readable storage medium of claim 17, wherein the method further comprising: building the graph structure by:
obtaining data from a plurality of psychographic surveys stored in a survey database;
performing an edge creation process based on the obtained data;
performing a community detection to obtain community structures; and
merging the community structures to obtain the graph structure comprising information of the psychological traits.

19. The non-transitory computer-readable storage medium of claim 17, wherein the method further comprising: building and tuning one or more behavior models by:
obtaining data from a plurality of behavior surveys stored in the survey database;
performing a data normalization to the obtained data;
binning the normalized data;
performing grid search parameter tuning to tune the one or more behavior models with behavior profiles; and
using outcome profiles to tune the one or more behavior models.

20. The non-transitory computer-readable storage medium of claim 17, wherein the method further comprising:
obtaining user data associated with the target user, the user data comprising the user profile and historical entries;
performing an edge creation process based on the obtained user data;
performing a graph similarity modeling process for psychological traits according to the graph structure;
performing a behavior prediction according to one or more behavior models with behavior profiles;
performing a user modulation, based on the outcome linkage analysis, to obtain outcome profiles; and
tuning user contributes based on the behavior and outcome profiles.
